(19) United States
(12) Patent Application Publication
(10) Pub. No.: US 2023/0149926 A1
(43) Pub. Date: May 18, 2023

(54) SPECIMEN COLLECTION TUBE

(71) Applicant: VECTORNATE KOREA CO., LTD., Jeollanam-do (KR)

(72) Inventors: Tae Seon YEOM, Woodcliff Lake, NJ (US); Ji Hyun SHIN, Naju-Si (KR)

(73) Assignee: VECTORNATE KOREA CO., LTD., Jeollanam-do (KR)

(21) Appl. No.: 17/529,066

(22) Filed: Nov. 17, 2021

(51) Int. Cl. B01L 3/00

(52) U.S. Cl. CPC B01L 3/502746; B01L 3/50825; B01L 3/5029; B01L 2300/042; B01L 2300/0832; B01L 2400/086; B01L 2300/0858

(57) ABSTRACT

The present invention relates to a tube for collecting specimens. The tube includes a tubular body having an inner surface which defines a hollow space for carrying a carrier solution or the like. The tube also includes a plurality of ridges projecting inwardly from the inner surface for engagement with at least a portion of a specimen collection tool for facilitating release of at least some of specimens therefrom.

### FIELD OF THE INVENTION

The present invention relates to collection tubes for collection of samples or specimens from collection tools, such as swabs and the like.

### BACKGROUND OF THE INVENTION

Various collection tubes have been developed in the past for collecting, storing and/or carrying biological specimens or samples from patients. The collection tube according to the present invention is intended to facilitate the transfer of specimens or samples from collection tools, such as swabs and the like, into the collection tube.

### SUMMARY OF THE INVENTION

In one embodiment, a tube for collecting specimens includes a tubular body having an inner surface which defines a hollow space for containing a carrier fluid and/or specimens. The tubular body includes a plurality of ridges projecting inwardly from the inner surface and configured such that at least a portion of a specimen collection tool containing specimens can be applied against at least some of the ridges so as to release at least some of the specimens from the portion of the specimen collection tool into the hollow space. In one embodiment, the ridges are oriented upwardly so as to facilitate loosening of the specimens from the portion of the specimen collection tool. In one embodiment, each of the ridges is slanted. In one embodiment, the ridges include a plurality of sets of ridges, the ridges of each of the sets of ridges being arranged in a vertical direction. In one embodiment, the ridges include at least one set of ridges, which are oriented upwardly in one direction, and at least another set of ridges, which are oriented upwardly in an opposite direction. In one embodiment, the ridges are arranged on the inner surface along the entire circumference of the hollow space. In one embodiment, the portion of the specimen collection tool includes a fibrous tip of a swab.

In one embodiment, a tube for collecting specimens includes a tubular body having an inner surface which defines a hollow space for containing a carrier fluid and/or specimens. The tubular body includes a first section and a second section, which is positioned generally opposite from the first section. The first section includes a plurality of first ridges, which project inwardly from the inner surface of the tubular body, while the second section includes a plurality of second ridges, which project inwardly from the inner surface of the tubular body. The first and second sections are configured such that they can be pressed toward each other such that the first ridges and the second ridges are movable toward each other so as to engage at least one portion of a specimen collection tool positioned therebetween. In one embodiment, the first ridges and the second ridges are configured such that the at least one portion of the specimen collection tool can be moved upwardly and downwardly so as to cause at least some specimens contained therein to be released into the hollow space. In one embodiment, each of the first and second sections is planar and located in a lower portion of the tubular body. In one embodiment, each of the first ridges and the second ridges is elongated in a generally horizontal direction. In one embodiment, the first ridges are arranged in a vertical direction, while the second ridges are arranged in the vertical direction. In one embodiment, the portion of the specimen collection tool includes a fibrous tip of a swab.

In one embodiment, a tube for collecting specimens includes a tubular body having an inner surface which defines a hollow space for containing a carrier fluid and/or specimens. The tubular body has a first section which includes a plurality of first ridges projecting inwardly from the inner surface and configured such that at least one portion of a specimen collection tool containing specimens can be scrubbed against at least some of the first ridges so as to release at least some of the specimens from the at least one portion of the specimen collection tool into the hollow space. The tubular body also includes a second section and a third section, which is positioned generally opposite from the second section. The second section includes a plurality of second ridges, which project inwardly from the inner surface of the tubular body, while the third section includes a plurality of third ridges, which project inwardly from the inner surface of the tubular body. The second and third sections are configured such that they can be pressed toward each other such that the second ridges and the third ridges are movable toward each other so as to engage at least another portion of the specimen collection tool positioned therebetween. In one embodiment, the first ridges are slanted upwardly so as to facilitate loosening of the specimens from the at least one portion of the specimen collection tool. In one embodiment, the first ridges include a plurality of sets of ridges, the ridges of each of the sets of ridges being arranged in a vertical direction. In one embodiment, the second ridges are arranged in the vertical direction, while the third ridges are arranged in the vertical direction. In one embodiment, the first ridges include at least one set of ridges, which are oriented upwardly in one direction, and at least another set of ridges, which are oriented upwardly in an opposite direction. In one embodiment, the second ridges and the third ridges are configured such that the at least another portion of the specimen collection tool can be moved upwardly and downwardly so as to cause at least some of the specimens contained therein to be released therefrom into the hollow space. In one embodiment, each of the second and third sections is planar and located in a lower portion of the tubular body, while the first ridges are arranged on the inner surface along the entire circumference of the hollow space. In one embodiment, each of the second ridges and the third ridges is elongated in a generally horizontal direction.

### BRIEF DESCRIPTION OF THE DRAWINGS

In the drawing figures, which are not to scale, and where like reference numerals indicate like elements throughout the several views:

FIG. 1 is a perspective view of a collection tube constructed in accordance with an embodiment;

FIG. 2 is a side elevational view of the collection tube shown in FIG. 1;

FIG. 3 is an enlarged view of a section of the collection tube shown in FIG. 2;

FIG. 4 is a front elevational view of the collection tube shown in FIG. 1;

FIG. 5 is a cross-sectional view, taken along section lines 5-5 and looking in the direction of the arrows, of the collection tube shown in FIG. 2; and

FIG. 6 is a schematic view of the collection tube shown in FIG. 1 during its use.

### DESCRIPTION OF EXEMPLARY EMBODIMENTS

Embodiments are now discussed in more detail referring to the drawings that accompany the present application. In the accompanying drawings, like and/or corresponding elements are referred to by like reference numbers.

Various embodiments are disclosed herein; however, it is to be understood that the disclosed embodiments are merely illustrative of the disclosure that can be embodied in various forms. In addition, each of the examples given in connection with the various embodiments is intended to be illustrative, and not restrictive. Further, the figures are not necessarily to scale, and some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Among other things, for example, subject matter may be embodied as methods, devices, components, or systems. The following detailed description is, therefore, not intended to be taken in a limiting sense.

Throughout the specification and/or claims, terms may have nuanced meanings suggested or implied in context beyond an explicitly stated meaning. Likewise, the phrase “in one embodiment” as used herein does not necessarily refer to the same embodiment and the phrases “in another embodiment” and “other embodiments” as used herein do not necessarily refer to a different embodiment. It is intended, for example, that covered or claimed subject matter include combinations of exemplary embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

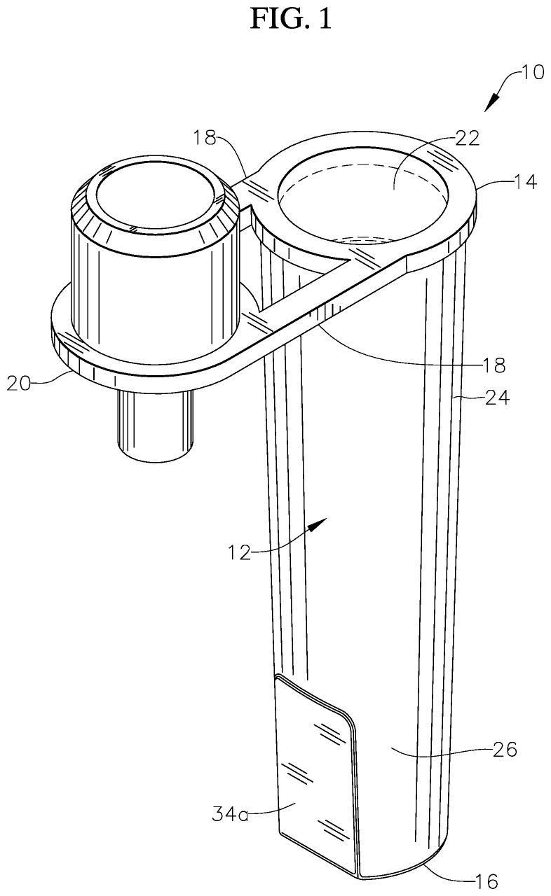

FIG. 1 illustrates a collection tube 10 constructed in accordance with an embodiment. In one embodiment, the collection tube 10 is adapted for collection of samples or specimens, such as nasal fluid, saliva or other biological fluid, solid or semi-solid samples, from patients. In other embodiments, the collection tube 10 can be used for collecting other types of samples, such as chemical samples or dirt.

In one embodiment, the collection tube 10 includes a tubular body 12 having an upper end 14 and a lower end 16. In one embodiment, the collection tube 10 includes one or more connectors 18, which is connected to the upper end 14 of the tubular body 12, and a cap 20, which is attached to the connectors 18. In one embodiment, the connectors 18 are flexible such that the cap 20 can be pivoted and releasably attached to the upper end 14 of the tubular body 12 in a sealing manner. In one embodiment, the connectors 18 can include one or more living hinges formed as a single piece with the tubular body 12 and the cap 20. In other embodiments, the connectors 18 can include any other types of connector, such as a strip or string that is connected to the tubular body 12 and the cap 20. In another embodiment, the cap 20 and the tubular body 12 can be detached from one another and/or formed as two separate, distinct units.

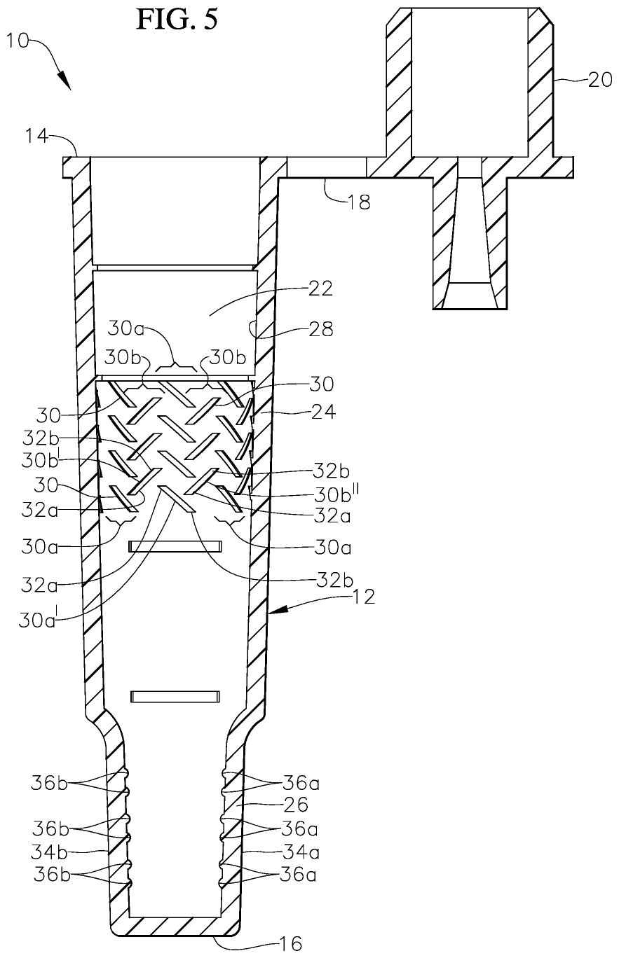

In one embodiment, the tubular body 12 is elongated and includes a hollow space 22 therein for containing a carrier solution and/or specimens or samples collected from a specimen collection tool, such as a swab. In one embodiment, the tubular body 12 has a tapered shape such that the diameter or size of the tubular body 12 gradually decreases as it extends from the upper end 14 to the lower end 16. In one embodiment, the tubular body 12 has an upper portion 24, which is located adjacent the upper end 12, and a lower portion 26, which is positioned adjacent the lower end 16. In one embodiment, the tubular body 12 has an inner annular surface 28 (see FIG. 5) facing the inside of the collection tube 10 and defining the hollow space 22.

Now referring to FIG. 5, in one embodiment, the upper portion 24 includes a plurality of elongated ridges 30 projecting from the inner annular surface 28 generally in a radially inward direction. In one embodiment, the ridges 30 are constructed and arranged such that a specimen collection tool, such as a swab, can be scraped or rubbed against at least some of the ridges 30 so as to facilitate the transfer of specimens or samples (biological or otherwise) contained on or in the specimen collection tool into the collection tube 10. In one embodiment, the ridges 30 are located between the upper end 14 and the lower portion 26 of the tubular body 12 such that when a sufficient amount of a carrier solution is added to the collection tube 10, they are submerged in the carrier solution. In one embodiment, the ridges 30 are formed along the entire inner circumference of the upper portion 24.

Still referring to FIG. 5, in one embodiment, each of the ridges 30 is oriented upwardly or slanted in an angular orientation so as to facilitate the transfer of specimens or samples from the specimen collection tool, as will be discussed in greater detail below. In one embodiment, each of the ridges 30 is slanted at about a 45° angle. In one embodiment, the ridges 30 include a plurality of sets of ridges 30a, which are slanted with their left sides positioned higher than their respective right sides, and a plurality of sets of ridges 30b, which are slanted with their right sides positioned higher than their respective left sides (i.e., in a direction opposite to the slant direction of the ridges 30a). In one embodiment, the ridges 30 in each of the sets of ridges 30a, 30b are vertically aligned with one another (i.e., spaced and stacked vertically). In one embodiment, each of the sets of ridges 30a are interposed between a corresponding pair of the sets of ridges 30b, while each of the sets of ridges 30b are interposed between a corresponding pair of sets of ridges 30a. In other words, the sets of ridges 30a and the sets of ridges 30b are arranged in an alternating fashion. In one embodiment, each of the ridges 30a, 30b overlaps laterally with a laterally adjacent pair of the ridges 30a, 30b. By way of example, the ridge 30a′ in FIG. 5 has ends 32a, 32b, which laterally overlap with an end 32b of the ridge 30b′ and an end 32a of the ridge 30b″, respectively. In one embodiment, each laterally adjacent pair of the ridges 30a, 30b (see, e.g., 30a′ and 30b′, or 30a′ and 30b″ in FIG. 5) generally form a V- or inverted V-shape for purposes to be discussed hereinafter.

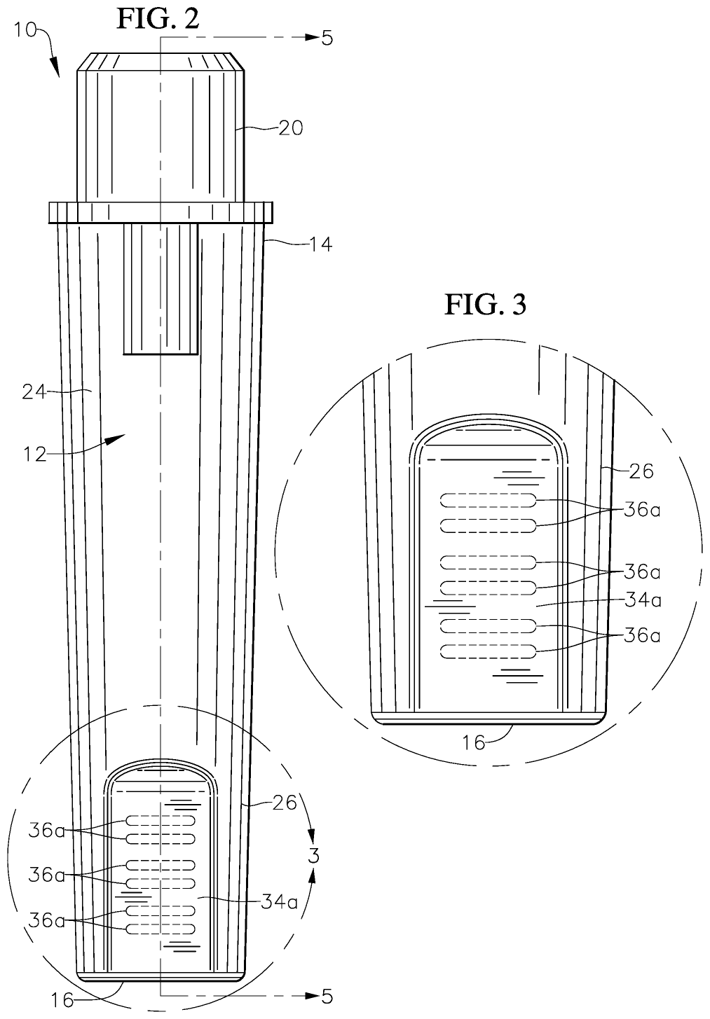

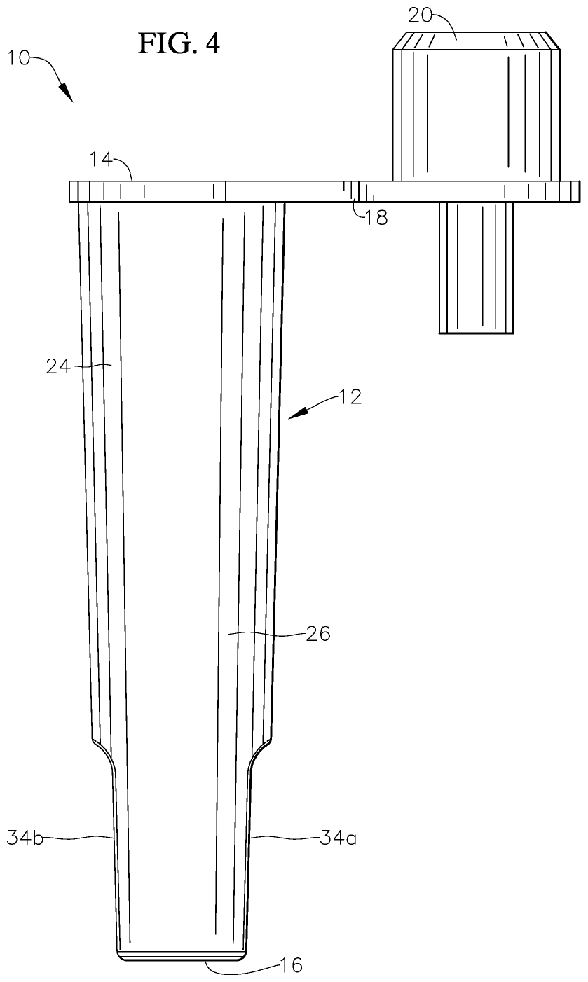

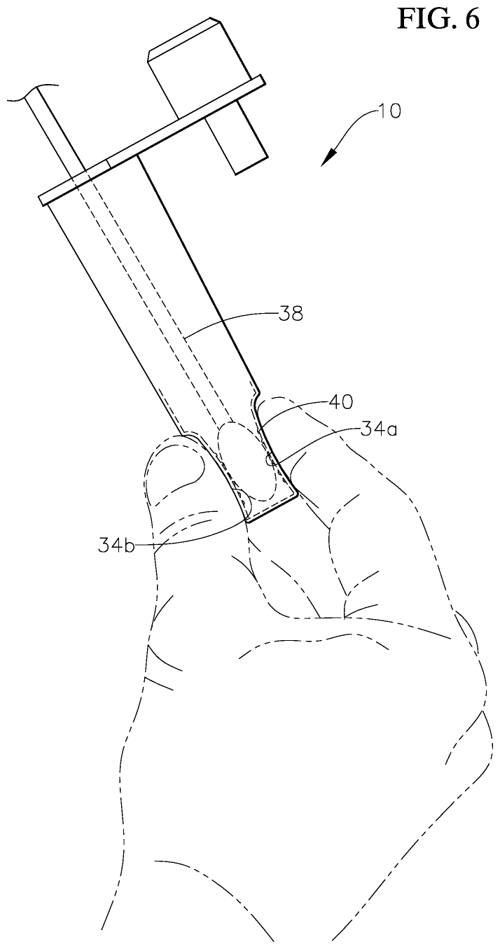

Now referring to FIGS. 2, 3 and 5, in one embodiment, the lower portion 26 of the tubular body 12 includes a pair of substantially planar sections 34a, 34b which oppose one another and each of which is sized and shaped to be pressed by a user's finger. In one embodiment, each of the planar sections 34a, 34b is elongated in a vertical direction. In one embodiment, the lower portion 26 includes a plurality of ridges 36a, 36b projecting generally in an inward direction from the inner surface 28 of the planar section 34a and the inner surface 28 of the planar section 34b, respectively. In one embodiment, the ridges 36a are elongated in a generally horizontal direction and are spaced and stacked the vertical direction, while the ridges 36b are elongated in the generally horizontal direction and are spaced and stacked in the vertical direction (see, e.g., FIGS. 2 and 3). In another embodiment, the ridges 36a and the ridges 36b can be elongated and/or arranged in other directions. In one embodiment, the distance between the planar sections 34a, 34b are shorter than the distance between the opposing sides of the upper portion 24 of the tubular body 12 (see, e.g., FIGS. 4 and 5). In one embodiment, the tubular body 12 (or at least the lower portion 26) is made from a flexible material such that the planar sections 34a, 34b and their respective ridges 36a, 36b can be moved towards one another by squeezing them with a user's fingers (see, e.g., FIG. 6) for purposes to be discussed hereinbelow.

Now referring to FIG. 6, a specimen collection tool 38 is used to collect samples or specimens from a patient. In one embodiment, the specimen collection tool 38 is a swab. In other embodiments, the specimen collection tool 38 can be other types of collection device. In one embodiment, samples or specimens to be collected by the specimen collection tool 38 are biological in nature. For instance, the specimen collection tool 38 in the form of a swab is inserted into a nose or mouth of a patient such that biological specimens or samples (e.g., nasal fluid or saliva) are absorbed or otherwise placed onto or into the specimen collection tool 38 (e.g., a fibrous tip of the swab). In other embodiments, samples or specimens to be collected can be non-biological (e.g., a chemical sample from a working surface, etc.).

Still referring to FIG. 6, in one embodiment, a tip 40 of the specimen collection tool 38 where desired samples are collected (e.g., the fibrous tip of the swab) is inserted into the collection tube 10 (with or without a carrier fluid) to transfer at least some of the samples from the tip 40 into the collection tube 10. In one embodiment, the tip 40 is positioned in the upper portion 24 of the collection tube 10 and is moved up and down against the ridges 30 so as to scrape off or squeeze out at least some of the samples from the tip 40. In one embodiment, each side of the tip 40 is sequentially scratched against the ridges 30 to scrape off the samples from substantially entire surface of the tip 40. In this regard, the “V”-shape formation of the ridges 30 (see, e.g., the ridge 30a′ and 30b′ forming a generally inverted V-shaped formation and the ridges 30a ′ and 30b″ forming a generally V-shaped formation) acts as a plow against the tip 40 when the tip 40 moves upwardly and downwardly against the ridges 30, facilitating loosening and extraction of the samples from the tip 40.

In one embodiment, the tip 40 is positioned in the lower portion 26 of the collection tube 10 between the planar sections 34a, 34b. With the tip 40 properly positioned in the lower portion 26, the planar sections 34a, 34b are pressed toward one another with a user's fingers, causing the ridges 36a, 36b to engage the tip 40. In one embodiment, the planar sections 34a, 34b squeeze the tip 40 to cause at least some of the samples to be discharged from the tip 40 into the collection tube 10. With the ridges 36a, 36b gently engaging the tip 40, the specimen collection tool 38 is then moved upwardly and downwardly so as to scrape or rub the tip 40 against the ridges 36a, 36b, causing an additional amount of the samples to be extracted from the tip 40.

It should be noted that the present invention provide numerous benefits and advantages. For instance, with the use of the ridges 30 and/or the ridges 36a, 36b, samples contained on or in the tip 40 of the specimen collection tool 38 can be effectively and efficiently transferred into the collection tube 10.

It will be understood that the embodiments described herein are merely exemplary and that a person skilled in the art may make many variations and modifications without departing from the spirit and scope of the invention. All such variations and modifications are intended to be included within the scope of the invention.

We claim:

1. A tube for collecting specimens, comprising a tubular body having an inner surface which defines a hollow space for containing a carrier fluid and/or specimens, said tubular body including a plurality of ridges projecting inwardly from said inner surface and configured such that at least a portion of a specimen collection tool containing specimens can be applied against at least some of said ridges so as to release at least some of the specimens from the portion of the specimen collection tool into said hollow space.

2. The tube of claim 1, wherein said ridges are oriented upwardly so as to facilitate loosening of the specimens from the portion of the specimen collection tool.

3. The tube of claim 1, wherein each of said ridges is slanted.

4. The tube of claim 1, wherein said ridges include a plurality of sets of ridges, said ridges of each of said sets of ridges being arranged in a vertical direction.

5. The tube of claim 1, wherein said ridges include at least one set of ridges, which are oriented upwardly in one direction, and at least another set of ridges, which are oriented upwardly in an opposite direction.

6. The tube of claim 1, wherein said ridges are arranged on said inner surface along the entire circumference of said hollow space.

7. The tube of claim 1, wherein the portion of the specimen collection tool includes a fibrous tip of a swab.

8. A tube for collecting specimens, comprising a tubular body having an inner surface which defines a hollow space for containing a carrier fluid and/or specimens, said tubular body including a first section and a second section, which is positioned generally opposite from said first section, said first section including a plurality of first ridges, which project inwardly from said inner surface of said tubular body, said second section including a plurality of second ridges, which project inwardly from said inner surface of said tubular body, said first and second sections being configured such that they can be pressed toward each other such that said first ridges and said second ridges are movable toward each other so as to engage at least one portion of a specimen collection tool positioned therebetween.

9. The tube of claim 8, wherein said first ridges and said second ridges are configured such that the at least one portion of the specimen collection tool can be moved upwardly and downwardly so as to cause at least some specimens contained therein to be released into said hollow space.

10. The tube of claim 8, wherein each of said first and second sections is planar and located in a lower portion of said tubular body.

11. The tube of claim 8, wherein each of said first ridges and said second ridges is elongated in a generally horizontal direction.

12. The tube of claim 8, wherein said first ridges are arranged in a vertical direction; and wherein said second ridges are arranged in the vertical direction.

13. The tube of claim 8, wherein the portion of the specimen collection tool includes a fibrous tip of a swab.

14. A tube for collecting specimens, comprising a tubular body having an inner surface which defines a hollow space for containing a carrier fluid and/or specimens, said tubular body having a first section which includes a plurality of first ridges projecting inwardly from said inner surface and configured such that at least one portion of a specimen collection tool containing specimens can be scrubbed against at least some of said first ridges so as to release at least some of the specimens from the at least one portion of the specimen collection tool into said hollow space, said tubular body including a second section and a third section, which is positioned generally opposite from said second section, said second section including a plurality of second ridges, which project inwardly from said inner surface of said tubular body, said third section including a plurality of third ridges, which project inwardly from said inner surface of said tubular body, said second and third sections being configured such that they can be pressed toward each other such that said second ridges and said third ridges are movable toward each other so as to engage at least another portion of the specimen collection tool positioned therebetween.

15. The tube of claim 14, wherein said first ridges are slanted upwardly so as to facilitate loosening of the specimens from the at least one portion of the specimen collection tool.

16. The tube of claim 14, wherein said first ridges include a plurality of sets of ridges, said ridges of each of said sets of ridges being arranged in a vertical direction; wherein said second ridges are arranged in the vertical direction; and wherein said third ridges are arranged in the vertical direction.

17. The tube of claim 14, wherein said first ridges include at least one set of ridges, which are oriented upwardly in one direction, and at least another set of ridges, which are oriented upwardly in an opposite direction.

18. The tube of claim 14, wherein said second ridges and said third ridges are configured such that the at least another portion of the specimen collection tool can be moved upwardly and downwardly so as to cause at least some of the specimens contained therein to be released therefrom in to said hollow space.

19. The tube of claim 14, wherein each of said second and third sections is planar and located in a lower portion of said tubular body; and wherein said first ridges are arranged on said inner surface along the entire circumference of said hollow space.

20. The tube of claim 14, wherein each of said second ridges and said third ridges is elongated in a generally horizontal direction.
